(19) United States
(12) Patent Application Publication
(10) Pub. No.: US 2008/0132431 A1
(43) Pub. Date: Jun. 5, 2008

(54) Scale squeeze treatment methods and systems

(76) Inventors: Floryan De Campo, Shanghai (CN); Allwyn Colaco, Princeton, NJ (US); Subramanian Kesavan, East Windsor, NJ (US)

Correspondence Address: Kevin E. McVeigh;RHODIA INC., 8 Cedar Brook Drive (CN 7500), Cranbury, NJ, 08512-7500, US

(21) Appl. No.: 11/998,550

(22) Filed: Nov. 30, 2007

Related U.S. Application Data
(60) Provisional application No. 60/861,801, filed on Nov. 30, 2006.

(51) Int. Cl. C09K 8/524

(52) U.S. Cl. 507/211

(57) ABSTRACT

An aqueous composition for treating hydrocarbon wells comprises an aqueous medium, a scale inhibitor, and a guar.

### BACKGROUND OF THE INVENTION

This invention relates to the treatment of hydrocarbon-containing formations. More particularly, the invention relates to fluids which are used to optimize the production of hydrocarbon from a formation, known as well completion fluids, and to methods of treating such formations. The invention specifically relates to scale inhibition treatment compositions and methods.

Contact of various inorganic compounds present in hydrocarbon bearing rock formations with compounds present in oilfield process fluids, such as seawater, sometimes leads to the formation and precipitation of “scale”, that is, water insoluble salts, such as barium sulfate and calcium carbonate, that can clog formation porosity and inhibit the flow of hydrocarbons from the formation to the wellbore. Scale inhibitors are used in oil fields to control or prevent scale deposition in the production conduit or completion system. Scale-inhibitor chemicals may be continuously injected through a downhole injection point in the completion, or periodic squeeze treatments may be undertaken to place the inhibitor in the reservoir matrix for subsequent commingling with produced fluids. Some scale-inhibitor systems integrate scale inhibitors and fracture treatments into one step, which guarantees that the entire well is treated with scale inhibitor. In this type of treatment, a high-efficiency scale inhibitor is pumped into the matrix surrounding the fracture face during leakoff. It adsorbs to the formation during pumping until the fracture begins to produce water. As water passes through the inhibitor-adsorbed zone, it dissolves sufficient inhibitor to prevent scale deposition. The inhibitor is better placed than in a conventional scale-inhibitor squeeze, which reduces the retreatment cost and improves production.

Scale inhibitor squeeze fluids are typically Newtonian fluids which have difficulties to reach low permeability regions of hydrocarbon formations, especially horizontal hydrocarbon well formations. As a result, squeeze treatment with such fluids is not efficient in these regions and may cause the deposit of scale which can then block these regions, resulting in decreased production rates.

SPE paper 94593 describes using fully viscosified scale squeeze fluids to help optimize the squeeze treatment by allowing the fluid to reach the low permeability region and the horizontal zones. This SPE paper describes use of a xanthan polymer to place scale inhibitor in a horizontal well. However, the paper admits that the xanthan needed a breaker to recover all of it. Leaving such compounds in the well could then be damaging for the formation which will eventually decrease the production efficiency.

It would be of great commercial value and importance to provide a hydrocarbon formation treatment scale inhibition composition and method of using that composition in a squeeze treatment which uses readily available, economical, easily modified or customized rheology modifiers.

### SUMMARY OF THE INVENTION

In a first aspect, the present invention is directed to an aqueous composition for treating hydrocarbon wells, comprising an aqueous medium, a scale inhibitor, and a guar

In a second aspect, the present invention is directed to a scale squeeze kit for use in hydrocarbon wells consisting of two parts, (A) and (B), wherein part (A) consists of a guar and part (B) consists of a scale inhibitor, the two parts being compatible and adapted to be mixed in an aqueous medium to form a viscous aqueous scale inhibitor solution.

In a third aspect, the present invention is directed to a method for treating a hydrocarbon well to inhibit scale, comprising:

mixing a scale inhibitor and a guar in an aqueous medium, to form a viscous scale inhibitor solution, and

introducing the viscous scale inhibitor solution into the well.

### DETAILED DESCRIPTION

Typically, water will be a major amount by weight of the treatment composition. Water is typically present in an amount by weight about 50% or more and more typically about 80% or more by weight of the treatment composition. The water can be from any source so long as the source contains no contaminants that are chemically or physically incompatible with the other components of the fluid (e.g., by causing undesirable precipitation). The water need not be potable and may be brackish and contain salts of such metals as sodium, potassium, calcium, zinc, magnesium, etc or other materials typical of sources of water found in or near oil fields.

Using fully viscosified scale inhibitors solutions improves the placement of the scale inhibitor during the squeeze treatments. Guars are compatible with typical scale inhibitors and have the advantage of minimizing the damage to the formation and maintaining high conductivity after the treatment and providing excellent fluid flowback. Guars are well known, natural galactomannan polysaccharide polymers which are used to modify viscosity of fluids and generate gels. Any guar can be used. Examples of suitable types of guars include non-derivatized guars, derivatized guars, such as cationic guars, carboxyalkyl guars, and hydroxyalkyl guars, and depolymerized or reduced molecular weight guars. Suitable guars are commercially available and include, for example a cationic guar, Jaguar™ C-17 guar, and hydroxypropyl guars Jaguar™8000 guar, Jaguar™ HP-60 guar and, Jaguar™ HP-120 guar, which differ in substitution level, each available from Rhodia Inc.

In one embodiment, the guar component of the present invention comprises a non-derivatized galactomannan polysaccharide. In another embodiment, the guar component of the present invention comprises a derivatized galactomannan polysaccharide that is substituted at one or more sites of the polysaccharide with a substituent group, independently selected for each site, from the group consisting of cationic substituent groups such as quaternary ammonium groups, nonionic substituent groups, such as hydroxyalkyl groups, and anionic substituent groups, such as carboxyalkyl groups.

In one embodiment, the guar component of the present invention comprises a derivatized guar selected from hydroxypropyl guar, hydroxypropyl trimethylammonium guar, hydroxypropyl lauryldimethylammonium guar, hydroxypropyl stearyldimethylammonium guar, carboxymethyl guar, and mixtures thereof. In one embodiment, the guar comprises a derivatized polycationic guar that comprises cationic substituent groups.

In one embodiment, the derivatized guar according to the present invention exhibits a total degree of substitution (“DS_{T}”) of from about 0.001 to about 3.0, wherein:

DS_{T} is the sum of the DS for cationic substituent groups (“DS_{cationic}”), the DS for nonionic substituent groups (“DS_{nonionic}”) and the DS for anionic substituent groups (“DS_{anionic}”),

DS_{cationic} is from 0 to about 3, more typically from about 0.001 to about 2.0, and even more typically from about 0.001 to about 1.0,

DS_{nonionic} is from 0 to 3.0, more typically from about 0.001 to about 2.5, and even more typically from about 0.001 to about 1.0, and

DS_{anionic} is from 0 to 3.0, more typically from about 0.001 to about 2.0. As used herein, the term “degree of substitution” means the number of substituent groups per saccharide unit of guar polysaccharide.

In one embodiment the guar has a molecular weight of greater than about 1,000,000 grams per mole, more typically of from about 1,500,000 to about 2,500,00 grams per mole.

In one embodiment the guar is a reduced molecular weight guar having a molecular weight of less than about 1,000,000 grams per mole.

In one embodiment, the scale treatment composition of the present invention comprises an amount of guar sufficient to increase the viscosity of the composition, as measured under low shear conditions to a value of from greater than about 10 to 100 centiPoise (“cp”), more typically from about 10 to about 50 cp and even more typically from about 10 to about 20 cp. As used herein, “low shear conditions” means a shear rate of less than or equal to about 100 reciprocal seconds (“s⁻¹”).

The scale treatment composition of the present invention typically exhibits a non-Newtonian, shear-thinning viscosity. In one embodiment, the viscosity of the scale treatment composition, as measured at a shear rate of greater than 100 s⁻¹, more typically greater than 150 s⁻¹ (“high shear conditions”), is less than the viscosity of the scale treatment composition as measured under low shear conditions.

In one embodiment, the scale treatment composition comprises from about 0.1 to about 50 percent by weight (“wt %”), more typically from about 0.1 to about 20 wt %, even more typically from about 0.1 to about 10 wt %, guar.

The scale inhibitor component of the scale treatment of the present invention can be any known scale inhibitor, including, for example, phosphate ester scale inhibitors, such as triethanolamine phosphate and salts thereof, phosphonic acid based scale inhibitors, such as aminomethylenephosphonic acid, 1-hydroxyethyl-1,1-diphosphonic acid and salts thereof, 2-hydroxyethylamino bismethylenephosphonic acid and salts thereof, phosphonocarboxylic acids, and polymeric polyanionic scale inhibitors. Suitable polymeric polyanionic scale inhibitors include homopolymers and copolymers comprising monomeric units derived from water soluble or partially water soluble ethylenically unsaturated monomers having an anionic substituent group, such as for example, acrylic acid, vinyl sulfonic acid, methacrylic acid, maleic acid, itaconic acid, fumaric acid, vinyl acetate, allyl alcohol, allyl sulfonic acid, vinyl phosphonic acid, vinylidene diphosphonic acid.

In one embodiment, the scale inhibitor comprises one or more compounds selected from diethylene triaminepentakis(methylenephosphonic acid)s or salts thereof, such as sodium diethylenetriaminepentakis(methylene phosphonate, 2, phosphonobutane-1,2,4-tricarboxylic acid, homopolymers of acylic acid, maleic acid, or vinyl sulfonic acid, co-polymers of vinylphosphonic acid and vinylsulfonic acid, co-polymers of maleic acid and allylsulfonic acid, co-polymers of vinyl phosphonic acid and vinyl sulfonic acid, phosphonic acid terminated oligomers, such as

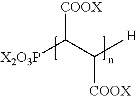

and phosphonic acid terminated polymers, such as for example,

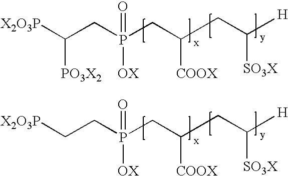

wherein X is H or an anion and x and y are chosen to obtain a ratio and MW which gives optimum performance, typically x+y is greater than or equal to 2 and less than or equal to 500.

The scale treatment composition of the present invention comprises an amount of scale inhibitor effective to inhibit scale formation under the conditions of use. More typically, the scale squeeze treatment composition of the present invention comprises, from about 0.01 to about 50 wt %, more typically from about 1 to about 20 wt % of the scale inhibitor.

In one embodiment, the scale treatment composition of the present invention comprises one or more scale inhibitors, one or more guars, and water. The composition may, optionally, further comprise other additives known in the art, such as for example, surfactants, corrosion inhibitors, and breakers, such as enzymes or oxidizers.

In one embodiment, the scale treatment composition of the present invention is used by injecting the composition, either continuously or periodically, into a hydrocarbon-bearing bearing rock formation to inhibit scale deposition in the formation.

Guars can be used with scale inhibitor squeeze solution to increase the viscosity and then improve the placement of such solutions in horizontal wells. The advantages of using guars are their ready availability at low cost, being easily modified, having improved shear-thinning profile, and robust salt tolerance. As a result, such fluid will not require the use of any breaker. In addition, guars currently used in fracturing fluids are known to avoid formation damage by maintaining high conductivity. Furthermore, it is believed that embodiments comprising a polycationic guar provide an additional benefit in that the polycationic guar acts as a coupling agent to provide improved retention of anionic scale inhibitors on anionic rock formation surfaces, such as silicate formation surfaces. Finally, guars do not undergo decomposition at high shear rate which can be the case of other polymers, such as poly(acrylamide) polymers.

### EXAMPLES

The following examples in which all parts and percentages are by weight unless otherwise indicated illustrate a few embodiments of the invention.

### Example 1

### Viscosity Measurements

A series of exemplary composition were made by combining water, a guar polymer (Jaguar™ C-17 guar (“G-1”), Jaguar™ HP-120 guar (“G-2”), each a commercial product available from Rhodia Inc., or a hydroxypropyl guar having a molecular substitution of 2.0 (“G-3”)) and a scale inhibitor (solutions were 10% actives solution of phosphonate end-capped polymer (“SI-1”, Aquarite ESL brand) and 10% actives solution of a phosphonate scale inhibitor, that is, diethylenetriamine tetrakis(methylenephosphonic acid (“SI-2”, Briquest 543-45AS brand)). Each of the exemplary compositions was made as follows. First, 200 ml scale inhibitor solution was added to a 1 L glass container jar placed on a two speed Warring Laboratory Blender. Next 0.1-1% by weight active of guar polymer was added to the jar. The blender speed was gradually adjusted ˜5000 rpm over about 20 seconds. Mixing was allowed to occur at this rate for the first 2 minutes. Then the blender speed was set to about 10,000 RPM for an additional 1 minute. The fluid was then poured and stored into a plastic container until the sample is completely de-aired.

Then each of the 200 ml de-aired samples of the exemplary compositions was poured into a 250 ml beaker for analysis on a Ofite Model 900 viscometer. The Ofite viscometer measures the couette flow between coaxial cylinders. Measurements were conducted at ambient temperature with varying shear rates/rpm.

Table 1 summarizes the viscosity results, expressed in centipoise (CP), obtained with various aqueous solutions of 0.3 wt % guar polymer and 10 wt % inhibitors, as measured under different shear conditions, expressed as rpm of the viscometer and shear rate.

TABLE 1
Rheology results

| | | | | | Viscosity (cP) | | |
|---|---|---|---|---|---|---|---|
| Scale | Inhibitor | | Guar | Visual | @ 5 rpm | @ 59 rpm | @ 100 rpm |
| Inhibitor | (wt %) | Guar | (wt %) | Description | (8.5 s⁻¹⁾ | (100 s⁻¹) | (170 s⁻¹) |
| SI-1 | 10 | G-1 | 0.3 | clear gel | 50.7 | 27.5 | 23.6 |
| | | G-2 | 0.3 | clear gel | 24.5 | 10.1 | 1.3 |
| | | G-3 | 0.3 | clear gel | 17.4 | 12.3 | 13.8 |
| SI-2 | 10 | G-1 | 0.3 | clear gel | 39.9 | 33.7 | 28.7 |
| | | G-2 | 0.3 | clear gel | 28.5 | 16.7 | 15.5 |
| | | G-3 | 0.3 | clear gel | 17.4 | 17.3 | 16.8 |

The results set forth in Table 1 show that with only 0.3% of the various guar polymers, both scale inhibitor solutions could be viscosified. G-1 guar, which is a polycationic guar, showed particularly good results. The results also showed a shear thinning profile wherein the solution viscosity decreased with increasing shear rate.

### Example 2

Ideally, the viscosity modifier should not alter the performance of the scale inhibitors for the intended application. The effect of the guar polymers on the performance of each scale inhibitor was evaluated. Two typical tests for squeeze treatment scale inhibitors were chosen:

A. Inhibition of barium and strontium sulfate scale (static test)

B. Adsorption onto sandstone

### A. Inhibition of Barium and Strontium Sulfate

Test brines were Sea Water (SW) and a 2,000 ppm Ca²⁺, Formation Water (FW), a moderate scaling formation water. Brines were made-up separately and their composition is given in the table below.

| | SW | FW |
|---|---|---|
| Ion | (mg/l) | (mg/l) |
| Na⁺ | 10,890 | 31,275 |
| Ca²⁺ | 428 | 2,000 |
| Mg²⁺ | 1,368 | 739 |
| K⁺ | 460 | 654 |
| Ba²⁺ | 0 | 269 |
| Sr²⁺ | 0 | 771 |
| SO₄²⁻ | 2,690 | 0 |

Inhibitor stock solutions of 10,000 ppm (based on SI active ingredient) were made up in DI water. The scale inhibitor solutions were the same for which the viscosity was measured. 50 mL of SW was measured and transferred into a plastic bottle and the appropriate amount of inhibitor stock solution was added. A blank (no inhibitor) and a control (50 mL DI water only) were also prepared. Then, 50 mL of FW was transferred into a separate plastic bottle and 1 mL of buffer solution was added to adjust the pH to 5.5. All the plastic bottles were placed into the oven at 95° C. for at least 1 h. Then each SW solution was poured into one FW solution.

Samples were taken after 2 and 22 hours. A 1 ml sample was taken with a 1 ml automatic pipette. This was injected into a plastic test tube containing 9 mls of a pre-prepared quench solution (28.559 g of KCl, 5 g of ScaleTreat 810 PVS in distilled water, adjusted to pH=8.0-8.5 with NaOH and made up to 5 litres in a 5 litre volumetric flask). A cap was placed on the test tube and the solution was well mixed. Each sample was analyzed for residual barium/strontium by ICP analysis within 48 hours.

The BaSO₄ and SrSO₄ scale inhibition efficiency was then calculated according to equation (5.1):

$$\% efficiency = \frac{[ {M}^{2 +} in sample ] - {[ {M}^{2 +} ]}_{min} \times 100}{{[ {M}^{2 +} ]}_{max} - {[ {M}^{2 +} ]}_{min}} \qquad ( 5.1 )$$

M²⁺=Sr²⁺ or Ba²⁺

[M²⁺]ₘₐₓ=M²⁺ content of maximum (FW/H₂O) control

[M²⁺]ₘᵢₙ=M²⁺ content of minimum (FW/SW) blank.

The results in the table below show that the presence of the various guar polymers did not affect significantly the performance of the scale inhibitor whether it was SI-1 or SI-2.

| | | Barium | | Strontium | |
|---|---|---|---|---|---|
| | Inhibitor | % Inhibition | | % Inhibition | |
| Inhibitor | AI (ppm) | 2 h | 24 h | 2 h | 24 h |
| SI-1 | 30 | 54.46 | 11.90 | 63.11 | 63.71 |
| SI-1 + 0.3 wt % G-1 | 30 | 58.04 | 11.11 | 83.01 | 80.24 |
| SI-1 + 0.3 wt % G-2 | 30 | 48.21 | 9.52 | 70.39 | 76.21 |
| SI-1 + 0.3 wt % G-3 | 30 | 54.31 | 15.70 | 72.82 | 54.03 |
| SI-2 | 15 | 91.38 | 63.64 | 87.38 | 82.26 |
| SI-2 + 0.3 wt % G-1 | 15 | 96.43 | 60.32 | 96.12 | 89.11 |
| SI-2 + 0.3 wt % G-2 | 15 | 90.18 | 42.06 | 100.00 | 85.48 |
| SI-2 + 0.3 wt % G-3 | 15 | 100.00 | 51.24 | 100.00 | 75.00 |

### B. Adsorption onto Sandstone

10 g of acid-washed crushed Clashach sandstone, with a particle size of 150-500 microns, are mixed with 20 ml of the 500 ppm scale inhibitor stock solution (adjusted at the desired pH) into a plastic bottle, placed in a tightly sealed bottle and heated in an oven at 90° C. and for 24 hours.

After this time, the samples are filtered under vacuum through a 0.45 μm membrane filter. Filtration is carried out at the specific temperature of interest in the experiment. The filtered supernatant are analyzed for the scale inhibitor content which using the formula below gives the amount of inhibitor adsorbed in ppm/mg of sand.

$$Adsorption ( mg polymer \text{/} gram sand ) = \frac{{(}_{*} {C}_{initial} - {C}_{final} ) {V}_{solution}}{{M}_{sand} 1000}$$

$${C}_{initial} = 500 ppm , {V}_{solution} = 20 mL , {M}_{sand} = 10 g$$

The results summarized below showed that none of the guar polymers altered significantly the adsorption of any of the two scale inhibitors.

| | Adsorption (ppm |
|---|---|
| Inhibitor | inhibitor/mg of sand) |
| SI-1 | 0.14 |
| SI-1 + 0.3 wt % G-1 | 0.13 |
| SI-1 + 0.3 wt % G-2 | 0.22 |
| SI-1 + 0.3 wt % G-3 | 0.11 |
| SI-2 | 0.33 |
| SI-2 + 0.3 wt % G-1 | 0.34 |
| SI-2 + 0.3 wt % G-2 | 0.34 |
| SI-2 + 0.3 wt % G-3 | 0.35 |

While the invention has been described and illustrated in sufficient detail for those skilled in this art to make and use it, various alternatives are within the spirit and scope of the invention and should become apparent.

What is claimed is:

1. An aqueous composition for treating hydrocarbon wells, comprising an aqueous medium, a scale inhibitor, and a guar.

2. The composition of claim 1, wherein the solution is about from about 0.1 to about 50 percent by weight active guar.

3. The composition of claim 1, wherein the solution is from about 1 to about 50 percent by weight active scale inhibitor.

4. The composition of claim 1, wherein the guar is selected from non-derivatized guars, derivatized guars.

5. The composition of claim 1, wherein the guar is selected from derivatized galactomannan polysaccharides that are substituted at one or more sites of the polysaccharide with a substituent group, independently selected for each site from the group, consisting of cationic substituent groups and nonionic substituent groups.

6. The composition of claim 1, wherein guar is selected from hydroxypropyl guar, hydroxypropyl trimethylammonium guar, hydroxypropyl lauryldimethylammonium guar, hydroxypropyl stearyldimethylammonium guar, carboxymethyl guar, and mixtures thereof

7. The composition of claim 1, wherein the guar is a cationic guar or a hydroxypropyl guar.

8. The composition of claim 1, wherein the scale inhibitor is a sulphonate-functional phosphonated copolymer or a soluble source of diethylene-triaminepentakis (methylenephosphonic acid).

9. The composition of claim 1, wherein the scale inhibitor is a solution of sodium diethylenetriaminepentakis(methylene phosphonate) or phosphonate end-capped copolymer.

10. The composition of claim 1, wherein the composition has a viscosity of from greater than about 10 to 100 centiPoise at a shear rate of less than or equal to about 100 reciprocal seconds.

11. A scale squeeze kit for use in hydrocarbon wells, said kit consisting of two parts, (A) and (B), wherein part (A) consists of a guar and part (B) consists of a scale inhibitor, the two parts being compatible and adapted to be mixed in an aqueous medium to form a viscous aqueous scale inhibitor solution.

12. The kit of claim 11, wherein the scale inhibitor is a phosphonate end-capped copolymer or diethylene-triaminepentakis (methylenephosphonic acid).

13. A method for treating a hydrocarbon well to inhibit scale, comprising:
mixing a scale inhibitor and a guar in an aqueous medium, to form a viscous scale inhibitor solution, and
introducing the viscous scale inhibitor solution into the well.

14. The method of claim 13, wherein the well is a horizontal well.
